(19) United States
(12) Patent Application Publication
(10) Pub. No.: US 2015/0126227 A1
(43) Pub. Date: May 7, 2015

(54) ZONE-BASED SOCIAL MEDIA

(71) Applicant: Michael F. Hoffman, Loudonville, NY (US)

(72) Inventor: Michael F. Hoffman, Loudonville, NY (US)

(21) Appl. No.: 14/532,300

(22) Filed: Nov. 4, 2014

Related U.S. Application Data
(60) Provisional application No. 61/899,607, filed on Nov. 4, 2013.

(51) Int. Cl. H04W 4/02; H04W 4/20

(52) U.S. Cl. CPC H04W 4/021; H04W 4/206
USPC 455/456.3

(57) ABSTRACT

A zone-based social media application (SMA) system, program product and method. A system is disclosed having a zone management system that employs a computerized process for managing a plurality of predefined geospatial zones, wherein the plurality of predefined geospatial zones include overlapping zones; a client management system that employs a computerized process for managing sessions with remote SMA clients; a locator system that employs a computerized process to associate each remote SMA client engaged in an active session with a predefined geospatial zone, wherein the locator system includes a process for selecting the predefined geospatial zone from a set of overlapping zones in response to an SMA client being located in an area predefined with overlapping zones; and a content information sharing infrastructure that employs a computerized process to deliver distinguishable sets of content to remote SMA clients based on an associated geospatial zone.

### PRIORITY CLAIM

This application claims priority to co-pending provisional application filed on Nov. 4, 2013, Ser. No. 61/899,607 entitled Zone-Based Social Media, the contents of which are hereby incorporated by reference.

### BACKGROUND

The present invention relates generally to social media, and more particularly relates to azone-based social media system, method and program product.

Social media applications (SMAs), such as Facebook, Twitter, LinkedIn, etc., continue to grow in importance in today's social fabric. Almost all SMAs work in a similar fashion. First, a user signs up for an account; second, the user forms connections, referred to for example as friends, followers, etc.; and thirdly, once the connections are established, information is shared between the user and the user's connections. The sharing of information is done in a variety of ways, including, e.g., as a news feed, as tweets, as photographs, etc. Further, the information is presented in various forms, including, e.g., mixed media, alpha-numeric messages, gameplay, etc.

SMAs have become ingrained in today's society for a variety of reasons, not the least of which is amusement. When a user has dead time, such as during a commute to work, while waiting in lines, taking work breaks, etc., SMAs give the user something of interest to pass the time. This, along with a bevy of other applications such as emailing, texting, gaming, etc., gives the user multiple avenues of engagement.

SMAs however do have certain shortcomings. Once such limitation is that the information shared is dictated by the user's connections and connecting with others in a meaningful way is an inexact science at best. For example, in SMAs such as Facebook, some users will connect with as many people as possible, while other users will only connect with close family and friends. Some users will post large amounts of information while others will rarely post. User posts will be considered downright annoying for some while entertaining to others. Users quickly recognize the frequency with which their connections post information as well as the interest level. Accordingly, because the number of connections is relatively static for most users, the user experience can become somewhat stale. The problem is particularly exacerbated for the casual user, who may completely stop using an SMA for large lengths of time, or quit the SMA altogether (sometimes referred to as so-called virtual identity suicide or Web 2.0 suicide).

Another problem with SMAs is that they generally promote the sharing of personal information at the expense of personal privacy. A growing number of people are uncomfortable making their personal information available to their connections as well as the public. Thus, there are segments of the population who do not take part in social media for privacy reasons.

### SUMMARY

The present invention addresses these as well as other problems by providing a zone based social media experience. A zone-based SMA system is disclosed that establishes connections among sets of users based primarily on the users be located in a predefined zone, rather than predefined personal connections such as friendships and followers. In one aspect, predefined zones may be defined as geographic regions or areas on a map. In another aspect, predefined zones may be defined as subject matter areas. In another aspect, predefined zones may be defined using clustering. In another aspect, predefined zones may be defined using natural language queries.

A zone-based social media application (SMA) system is disclosed implemented on a computing system having a processor and memory, comprising: a zone management system that employs a computerized process for managing a plurality of predefined geospatial zones, wherein the plurality of predefined geospatial zones include overlapping zones; a client management system that employs a computerized process for managing sessions with remote SMA clients; a locator system that employs a computerized process to associate each remote SMA client engaged in an active session with a predefined geospatial zone, wherein the locator system includes a process for selecting the predefined geospatial zone from a set of overlapping zones in response to an SMA client being located in an area predefined with overlapping zones; and a content information sharing infrastructure that employs a computerized process to deliver distinguishable sets of content to remote SMA clients based on an associated geospatial zone.

A computer program product stored on a computer readable medium, which when executed by a computer system, implements a zone-based social media application (SMA) system is disclosed, comprising: program code for managing a plurality of predefined geospatial zones; program code for managing sessions with remote SMA clients; program code to associate each remote SMA client engaged in an active session with at least one predefined geospatial zone; program code to deliver distinguishable sets of content to remote SMA clients based on an associated geospatial zone; and program code to cluster SMA clients into separate clusters within at least one predefined geospatial zone based on profile vectors, wherein each cluster receives cluster based content.

A computerized method for implementing a zone-based social media application (SMA) system is disclosed, comprising: managing a plurality of predefined geospatial zones; managing sessions with remote SMA clients; associating each remote SMA client engaged in an active session with at least one predefined geospatial zone; generating queries to end users and receiving responses to queries; and delivering distinguishable sets of content to remote SMA clients based on an associated geospatial zone and based on received responses.

### BRIEF DESCRIPTION OF THE DRAWINGS

These and other features of this invention will be more readily understood from the following detailed description of the various aspects of the invention taken in conjunction with the accompanying drawings.

FIG. 1 depicts a zone based SMA system in accordance with an embodiment of the invention.

FIG. 2 depicts an interface for defining zones in accordance with an embodiment of the invention.

FIG. 3 depicts illustrative zone in accordance with an embodiment of the invention.

FIG. 4 depicts an illustrative SMA newsfeed running on a client device in accordance with an embodiment of the invention.

FIG. 5 depicts an illustrative SMA zone management interface running on a client device in accordance with an embodiment of the invention.

FIG. 6 depicts an illustration of a user entering a zone in accordance with an embodiment of the invention.

FIG. 7 depicts further aspects of a zone-based SA system 20 in accordance with an embodiment of the invention.

FIG. 8 depicts an illustrative perusal system interface running on a client device in accordance with an embodiment of the invention.

FIG. 9 depicts a flow diagram of a method of implementing a zone based SMA system in accordance with an embodiment of the invention.

The drawings are merely schematic representations, not intended to portray specific parameters of the invention. The drawings are intended to depict only typical embodiments of the invention, and therefore should not be considered as limiting the scope of the invention. In the drawings, like reference numbering represents like elements.

### DETAILED DESCRIPTION

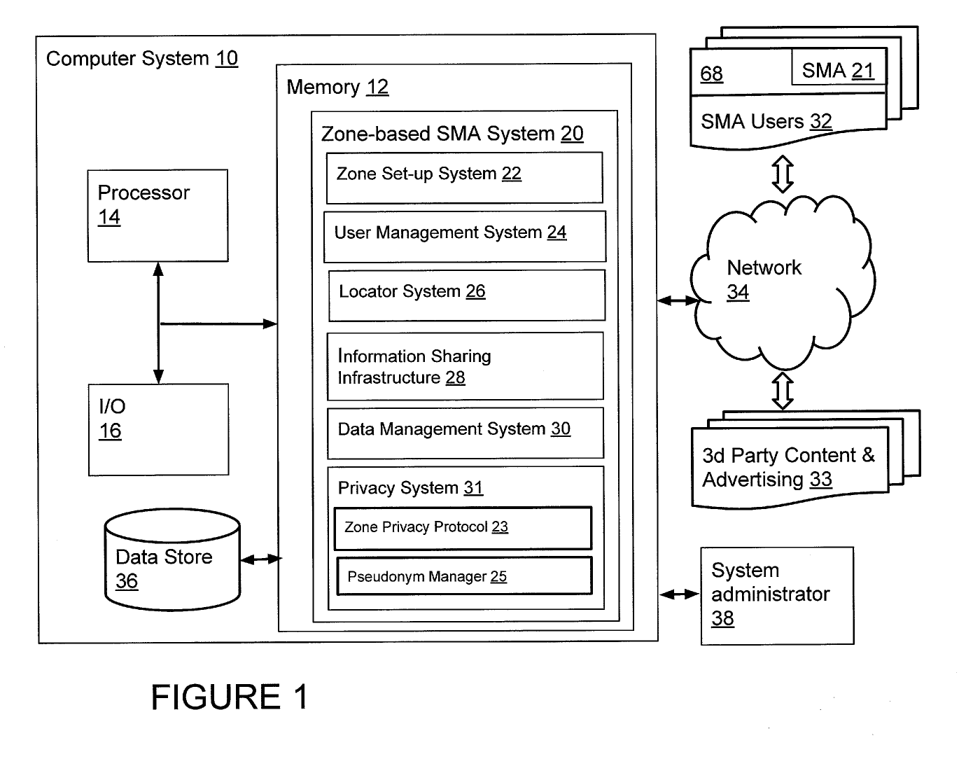

Referring now to the drawings, FIG. 1 depicts a computer system 10 having a zone-based social media application system (SMA system) 20 stored in memory 18. In one embodiment, SMA system 20 determines social media connections and content delivery based on predefined geospatial zones. Accordingly, connections among SMA users 32 via network 34 are primarily based on the SMA users 32 being commonly located in a predefined zone, rather than being based on predefined personal connections such as friendships and followers. Similarly, third party content (advertisements, offers, ancillary content, etc.) flowing to each SMA user 32 is dependent on the zone the user 32 resides within.

SMA system 20 includes a set of sub-components, which when executed by processor 14, implements a social media environment that is leveraged by users 32 running a remote or client social media application (SMA) 21, e.g., on a smartphone or other network connected device. Although shown as being embodied on a single computer system 10, it is understood that computer system 10 can be implemented using a distributed or cloud based computing environment.

As shown, SMA 20 includes: (1) a zone set-up system 22 that establishes predefined geospatial zones; (2) a user management system 24 that provides the communication infrastructure with SMAs 21, manages active user sessions, provides user registration facilities, etc.; (3) a locator system 26 that locates users 32 and determines which zone or set of zones each user is located in; (4) an information sharing infrastructure (ISI) 28 that packages third party content and advertising 33 for different zones and shares data among connected users residing within common zones, e.g., using a news feed type interface; (5) a data management system 30 that stores and manages data flowing through SMA system 20, including, e.g., user posts and third party content and advertising 33; and (6) a privacy system 31 that acts to protect privacy of the SMA users 32.

As noted, zone set-up system 22 provides a mechanism for creating zones. In one illustrative embodiment, zones comprise geographically definable (“geospatial”) zones that may be created by a system administrator 38, although it is understood that zones could likewise be created by users 32, third parties or some automated process. In one embodiment, zone set-up system 22 may for example include a map interface (such as that found on Google Maps), along with a set of tools that allow for the creation of enclosed or defined areas on the map interface. For example, zone set-up system 22 could allow system administrator 38 to digitally place an enclosed boundary (e.g., rectangle, oval, freehand line segments, etc.) on an area of a map interface.

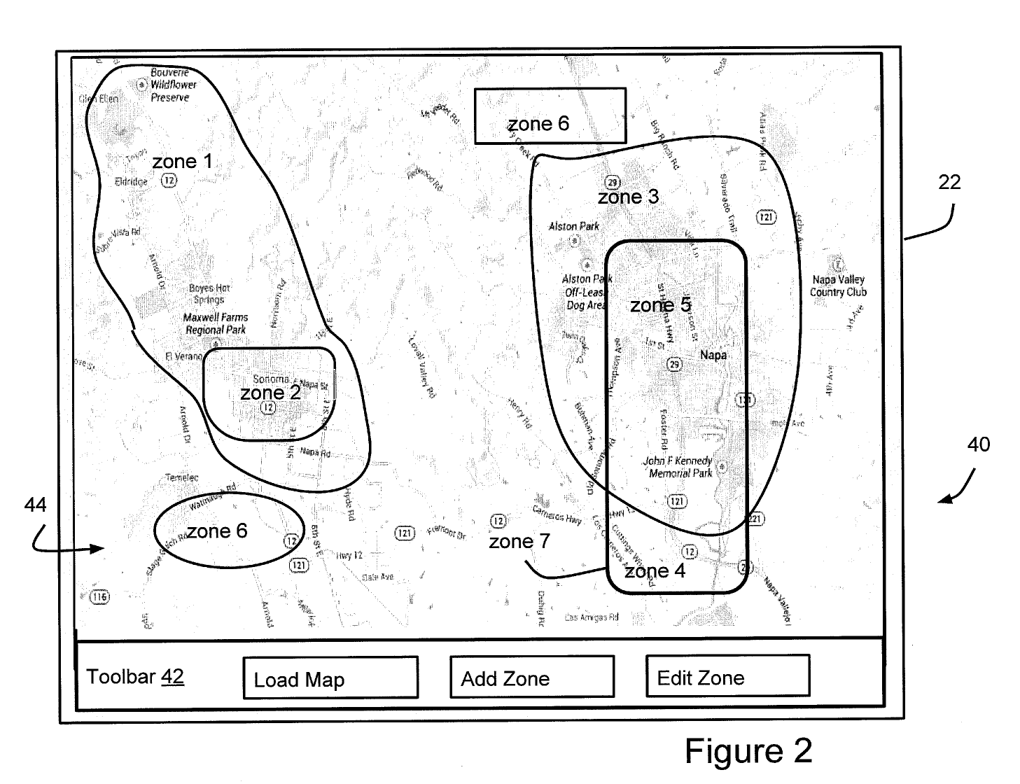

Any mechanism for defining an enclosed geospatial zone on a geographic surface of the earth may however be used. For instance, FIG. 2 depicts a zone set-up system 22 that utilizes a map interface tool 40 to define zones. Map interface tool 40 includes a viewing window 44 in which an administrator can view and interact with a digitized map image, and a toolbar 42 for implementing user-selectable functions and tools to allow the administrator to load and manipulate map images and create and edit zones. Using the map interface tool 40, the administrator can manipulate map image data within the viewing window 44 using commonly known navigation and mapping tools such as zoom, pan, and search. Further, the user can view the map area in various modes, e.g., satellite, street, 3D, etc.

Toolbar 42 provides access to commonly known drawing tools, such as those found in drawing programs, e.g., select/insert shapes, insert lines, move, cut/paste, etc., to facilitate the creation of zones in the viewing window 42. For instance, the administrator can define one or more zones by placing enclosed shapes onto the map image. As can be seen, zones can be created and defined in any manner using any shape type, e.g., zones can be stand-alone, overlapping, enclosed within another zone, disconnected, etc. For instance, in this example, it can be seen that zone 2 is contained within zone 1 Thus, if a user was located in zone 2, they may also be located in zones 1. Further, it can be seen that a portion of zone 3 overlaps with zone 7 to create zones 4 and 5. Further, a single zone may be physically disconnected into separate parts, such as zone 6. Accordingly, using map interface tool, any desired zone configuration can be implemented across any land area using zone set-up system 22.

It is understood that while the number, location and shape of the predefined zones is relatively static, new zones can be created, modified and removed as needed using the zone set-up system 22. In a typical scenario, a zone might be created to match, e.g., a man made structure, municipality boundaries, physical land feature, areas of interest, etc. For instance, zones can be created to encompass, e.g., a city, a town, a shopping mall, a stadium, a university, a hospital, a park, an office, an airport, a resort area, a beach, a ski mountain, a business zone, a neighborhood, etc. Zones can be as large or as small as desired, ranging for example from the entire earth down to small room. Further, although described herein as existing in two dimensions, it is understood that zones could encompass three dimensional spaces. For instance, different floors in a skyscraper could belong to different zones.

In a further illustrative embodiment, zones can be automatically generated using an algorithm that analyzes data and determines zone locations. For example, zones could be automatically generated based on county or city borders, postal codes, population data, physical features such as rivers or highways, etc. Moreover, zones and/or zone boundaries could be dynamic in nature, with zones being created and removed and boundaries shifting. For example, a zone may be created around a football stadium during a game, and be removed when the game is over. Further a zone's boundaries may change during work hours, or between weekdays and weekends.

Once a zone is defined, any SMA user 32 who enters the zone is associated with (or becomes a resident of) that zone and is automatically connected with every other SMA user 32 in the zone. Thus, for example, if a zone encompasses a football stadium property, every SMA user 32 attending a game at the stadium would be connected while they were in the defined zone. In essence, every user 32 in the zone becomes “temporal” friends with every other SMA user 32 in the zone. Once an SMA user 32 leaves the zone, they automatically disconnect from those SMA users 32 still in the zone. This allows SMA users 32 to establish meaningful connections in a temporal or situational fashion. A benefit is that SMA users 32 have the ability to automatically connect with others sharing a common experience. This thus allows for the exchange of more timely, meaningful and useful information in a social media environment.

In addition, all users residing in or associated with a zone generally receive the same third party content and advertising 33. Thus, users 32 entering a football stadium may for example receive ticket offers for upcoming events, information about the team, information about the stadium, scoring updates, media feeds including instant replay, etc.

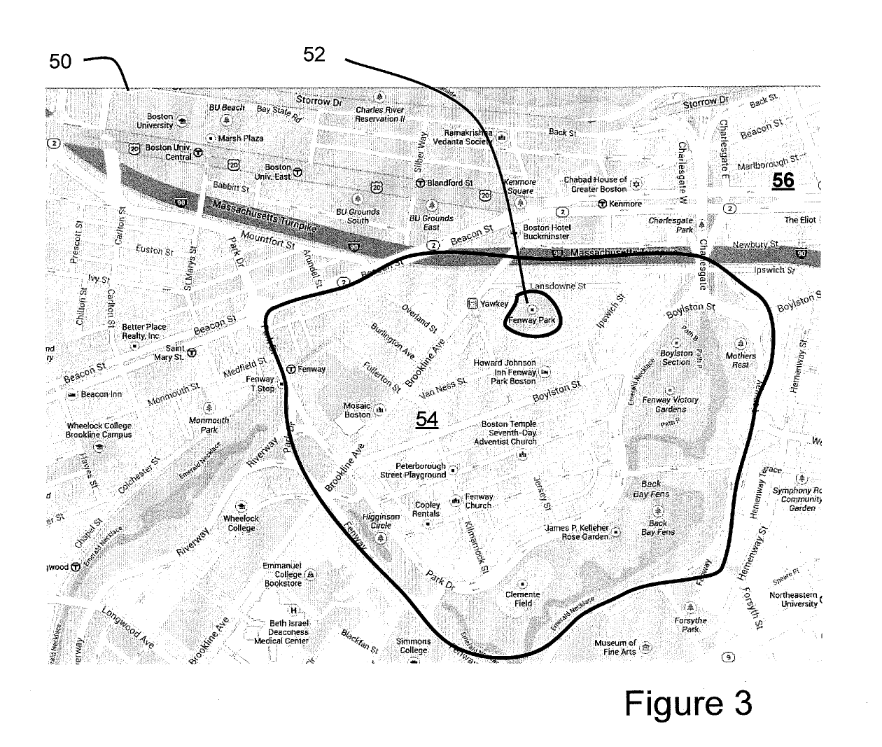

The concept of predefined zones is further illustrated in FIG. 3, which depicts a map 50 showing a portion of the greater Boston, Mass. area with three predefined zones. Zone 52 essentially comprises Fenway Park, while zone 54 essentially comprises the Fenway neighborhood. Zone 56 includes the entire greater Boston area (boundaries not shown in this view). Accordingly, SMA users in Fenway Park (zone 52) watching a ballgame will be automatically connected with all other SMA users in Fenway Park and receive the same third party content and advertising. Similarly, SMA users in the Fenway neighborhood (zone 54) will be connected with other SMA users in the Fenway neighborhood.

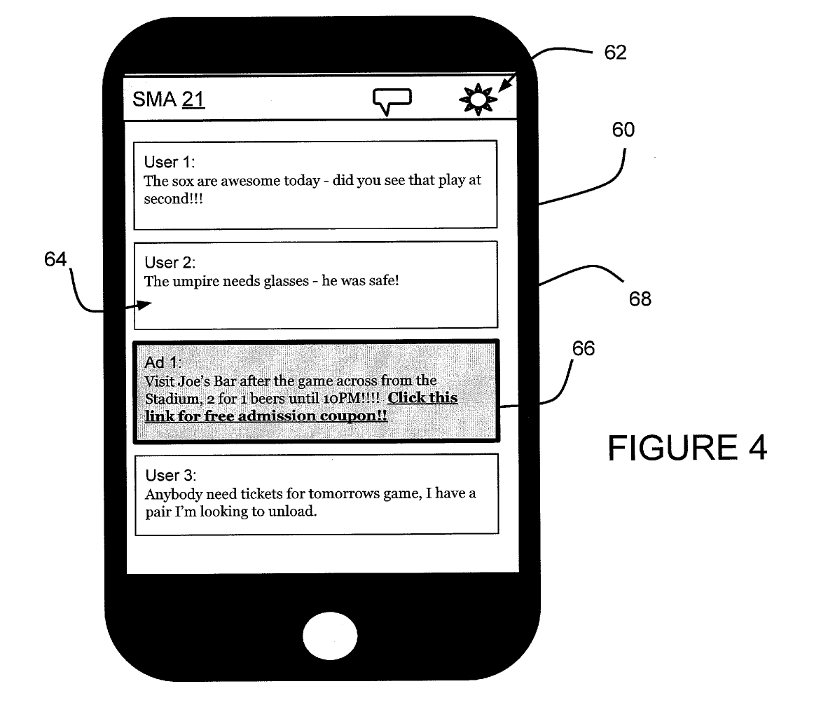

FIG. 4 depicts an illustrative user interface 60 for SMA 21 running on a smartphone 68. The illustrative SMA 21 comprises a news feed (e.g., similar to Facebook) that for example allows an SMA user to post message, photos, etc., read and scroll the newsfeed 64, like and comment on existing posts, etc. Included in the newsfeed 64 are, e.g., user comments, third party content and third party advertisements 66. Advertisers may for example pay to have their ad 66 appear in the newsfeed 64 in a more prominent or frequent fashion. It is understood that the type of interface to present content within SMA 21 is not limited to a particular form. For example, an SMA interface similar to Twitter, Instagram, Pinterest, LinkedIn, YouTube, Hulu, could be utilized. A relevant feature of the invention however is that SMA users in a predefined zone are automatically connected with each other, without the need to pre-establish friendships, followers, etc. Thus, as shown in FIG. 4, user 1, user 2 and user 3 are all connected while in a common zone even though they may not otherwise know each other. Further such users enjoy the benefit of content and advertising tailored to the zone.

Included in SMA 21 is a set of user options (available via menu icon 62), which may include any standard features that are typically found in known SMAs. User options for example may include the ability to post messages, instant message other SMA users, find users, attach photos, establish/manage a profile, etc. In addition, zone-based user options may also be provided to allow the SMA user to, e.g., manage zone residency rules, request access to a different zone, etc.

Management of zone residency rules may be required when zones overlap. For instance, as shown in FIG. 3, users in zone 52 are technically also in zones 54 and 56. In one illustrative embodiment, the default rule when the SMA user falls into overlapping or concentric zones is to place the user in the smallest, most granular zone. Accordingly, if an SMA user enters zone 52 (Fenway Park), the default rule may be set such that the user should only connect with other users in that zone 52. However, there may be instances when a user does not want to be limited to connections in the smallest zone, but would rather connect with other users in a larger surrounding zone. For example, the user may want to connect with everyone in the Fenway neighborhood zone 54.

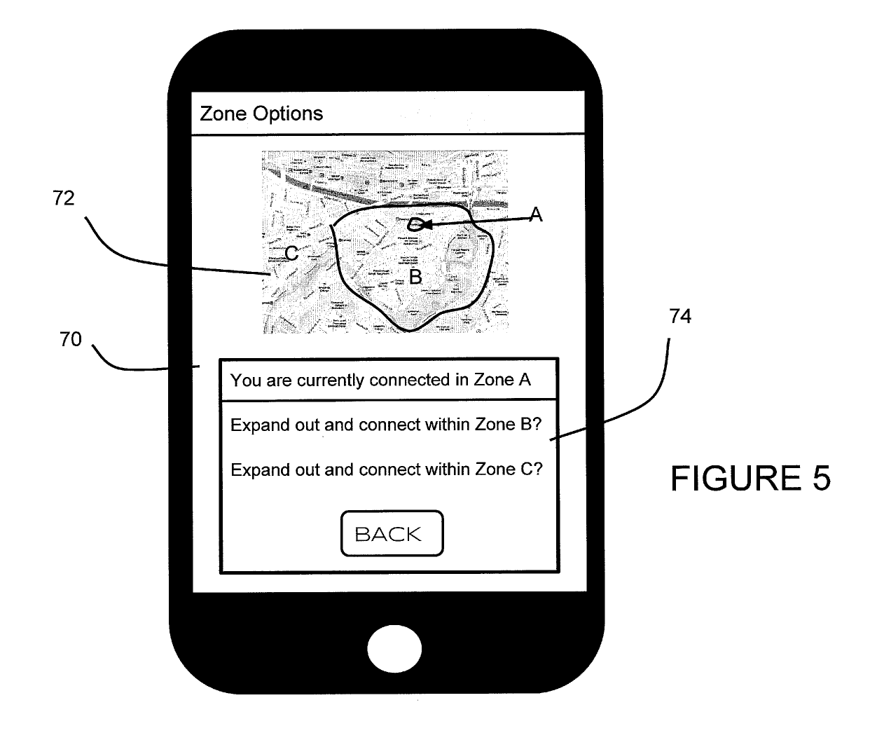

FIG. 5 depicts an illustrative zone options page 70 that allows the user to select which zone they want to participate in when they fall into more than one zone (e.g., both an inner zone and an outer zone; two overlapping zones, etc.). In this example, zone options page 70 includes a map of the available zones, as well as a selection window 74 for selecting/changing zones. In this case, the SMA user is located in an inner zone A, which is in turn contained in an outer zone B, which is in turn contained in a further outer zone C. Various implementation options/rules are possible when a user is situated in multiple possible zones. This interface allows the SMA user to achieve a desired outcome.

For instance, depending on the implementation, selecting zone B in FIG. 5 may or may not allow the user to participate with users in zone A. For example, users in zone B may be primarily interested in neighborhood news and not interested in the ballgame. Thus, it may not make sense to connect and co-mingle users and their comments between the zones. In other cases, users in a larger zone may be interested in information being shared in subsumed inner zones. To address this, zones may have predetermined rule settings when they are created. An Illustrative set of rules for a defined zone may for example be as follows:

(1) Exclusive: only allow connections within that zone.

(2) Nonexclusive: allow connections between inner and outer zones.

(3) Connected: connect with a non-contiguous zones

(4) User selectable: Allow the user to dictate whether connections can be established in either/both the inner and outer zone.

In addition to zone set-up system 22, SMA system 20 also includes a user management system 24 (FIG. 1) that provides the framework for managing SMA users 31, including: providing user registration facilities, providing a communication infrastructure, managing SMA user sessions, etc. In many aspects, user management system 24 may be implemented in a manner similar to other known SMAs. Accordingly, user management system 24 maintains user account data, and recognizes when a user has an active SMA session running on a client device, such as a smartphone. For the purposes of this disclosure, the term “active session” may include any case where the user's device is in at least some type of periodic or sporadic communication with the SMA system 20.

User registration may be implemented in a standard mode and/or a privacy mode. In a standard mode, SMA users 31 register in order to, e.g., establish a permanent username and account, create a profile, obtain user rights, etc. In privacy mode, SMA users 31 can participate without creating an account, and participate using randomly generated user names or pseudonyms. In privacy mode, temporary accounts and pseudonyms are automatically assigned to users 32 when they launch the SMA 21. Zone-based SMA system 20 may allow for either, or both, standard and private modes to provide for either or both registered and unregistered users. Allowing users to participate in privacy mode without a permanent account using pseudonyms provides user privacy. Further privacy features are described herein.

In an implementation that provides for both standard and private modes, rights and access to content can depend on the type of mode utilized by the user. For example, registered users could receive a more “open” set of rights, features, etc., relative to the unregistered users. For example, registered users may be afforded advanced features such as messaging with other registered users. Further, in a high volume newstream, posts by registered users could take precedent over posts by unregistered users. In one embodiment, users could toggle back and forth between standard and privacy modes.

Once zones are defined and SMA users have established active sessions, locator system 26 provides the mechanism for determining which zone or zones each active SMA user 32 is located in. In one embodiment, a global positioning system (GPS) feature of a user's smart device may be exploited to provide current coordinates of the user. Any means for locating the user's device however may be employed, e.g., triangulation using cellular data. Regardless, location data of each SMA user running an active session can be periodically analyzed by locator system 26 to determine which zone(s), if any, each user falls is.

In illustrative embodiments, each zone defined by the zone set-up system 22 may be stored as a set of geospatial or geographical coordinates using latitude and longitude. For example, the coordinates of a set of x number of points along a defined zone's perimeter may be stored. Once an active SMA user session is detected, the coordinates (i.e., map location) of the associated device running the SMA 31 can be determined using GPS, which are forwarded back to the SMA system 20, and compared or analyzed against the set of points for each zone to determine if the SMA user is located in a zone. Algorithms for determining if a spatial point is located within an enclosed space or region are well known in the art, and any such algorithm could be used.

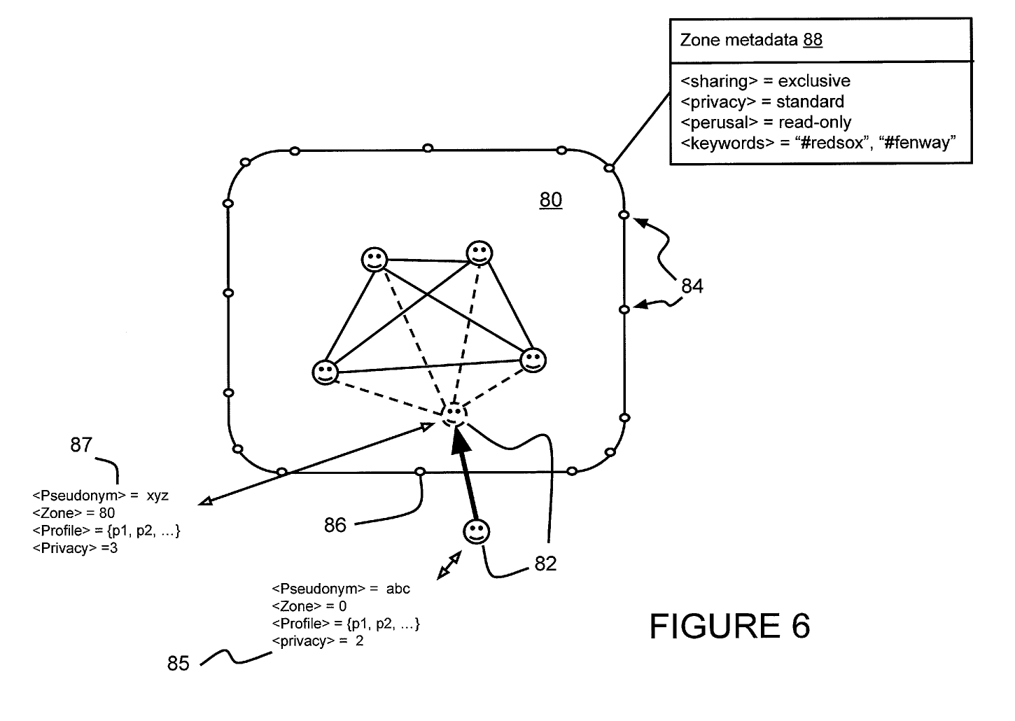

FIG. 6 illustrates various aspects of the SMA system 20, in which an SMA user 82 enter a new zone 80. Initially, there are four SMA users (shown in solid) in zone 80 and a fifth SMA user 82 outside the zone 80. Prior to entering zone 80, it can be seen that each of the four SMA users are connected to each other, but are not connected to SMA user 82. However, once user 82 enters zone 80, user 82 is connected with each of the other SMA users (shown in dashed lines). Connected users participate in the sharing of social media data as though they were friends, followers, etc. Thus for instance, once user 82 enters zone 80, user 82 sees all posts made by the other four users and the other four users see also posts made by user 82.

To further illustrate how zone locator 26 operates, FIG. 6 also shows a set of points 84 located along the perimeter of zone 80, which in this illustrative embodiment, describe how zone 80 is defined and stored when created by zone set-up system 22. Each point 84 in this case comprises a geographic coordinate which is stored in a data structure, array or table, and includes, e.g., degrees, minutes and seconds for latitude and longitude, e.g., (x1, x2, x3 N) (y1, y2, y3), as shown in the following table.

| Zone 80 | lat/long |
|---|---|
| P1: | (x1.1, x2.1, x3.1 N) (y1.1, y2.1, y3.1) |
| P2: | (x1.2, x2.2, x3.2 N) (y1.2, y2.2, y3.2) |
| P3: | (x1.3, x2.3, x3.3 N) (y1.3, y2.3, y3.3) |
| Etc. | |

In order to determine if user 82 is in zone 80, locator system 26 may implement one or more mathematical algorithms that analyze the user's current geographic coordinates against the zone's geographic coordinates. For example, for a relatively rectangular zone, a user would be deemed in the zone if locator system 26 determined that the user's coordinates were: (1) south of the northernmost point; (2) north of the southernmost point; (3) east of the westernmost point; and (4) west of the easternmost point. As can be seen in FIG. 6, locator system 26 could readily determine that user 82 is initially south of the southernmost point 86 prior to entering the zone 80 by comparing the user's latitude against the latitude of the southmost point 86. As such, user 82 would not be initially associated with zone 80. However, once user 82 enters the zone 80, locator system 26 would properly calculate that user 82 is north of the southernmost point 86 and the user would be associated with zone 80. Accordingly, using simple mathematical compare operations of a user's latitude and longitude against coordinates for each zone would dictate which zone(s) if any the user falls into.

It is understood that any algorithm for determining whether a user falls into a zone could however be utilized. Given the potentially large number of zones, optimized techniques can be employed to reduce computational overhead. For example, locator system 26 may perform an initial computation to first locate a likely set of nearby zones, and then determine if the user falls within one or more zones. This way, locator system 26 is not performing calculations for zones on the west coast while the user is clearly on the east coast.

Information sharing infrastructure (ISI) 28 is utilized to determine which user content and third party content and advertising 33 should flow into and among each zone. Because SMA users 32 will likely be entering and leaving zones in an ongoing fashion, ISI 28 must be continuously/periodically updated by locator system 26 regarding the SMA users in each zone. In order to effectuate the distribution of zone-based content, ISI 28 is implemented to react to the dynamic nature of users changing zones, continuously or periodically determining which users belong to which zones.

ISI 28 manages (i.e., packages and delivers) the flow of social media content into each zone in any manner. In one embodiment, a set of metadata is associated with each user and indicates the current zone or residence for each user. For example, FIG. 6 depicts a set of metadata 85, 87 for user 82 before and after entering zone 80. Prior to entering zone 80, metadata 85 tag <zone> is set to 0, indicating that the user 82 is not currently associated with a zone. Once in, user 82 has an updated set of metadata 87 that reflects <zone> being set to 80. As such, metadata with each user in zone 80 would include the tag <zone>=80. The user metadata may be stored at the SMA system 20, on the user device, at some other location, or be distributed.

In one embodiment, with each user tagged with a zone identifier, ISI simply forwards zone specific content to users based on the zone identifier stored in each user's metadata. Thus, e.g., users in a first zone are delivered a first set of zone specific content, users in a second zone are delivered a second set of zone specific content, etc.

In addition to storing a zone identifier, user metadata 85, 87 may include a name or pseudonym of the user, a profile vector of the user and a privacy setting or vector. In the case of user engaged in a privacy mode, a pseudonym would be automatically generated for the user (e.g., abc). Privacy system 31 of FIG. 1 may utilize a pseudonym manager to generate new names and to provide secure and private linkage between the device (e.g., user's smartphone) and the SMA system 20. Depending on what and how information is being communicated, device data (e.g., IP address, phone number, GPS identifier, etc.) may be necessary to effectuate communication.

One method to provide a more secure and private linkage is to utilize a proxy that sits between each user device and the SMA system 20. The proxy would be employed to prevent SMA system 20 from accessing any device data. Instead, SMA system 20 would only obtain account names, which in some cases could be randomly generated pseudonyms. The proxy may include a tamper proof secure processor that maps device data to account names in a secure environment. The proxy may also be responsible for generating pseudonyms for users in privacy mode, in which pseudonyms are linked to device data. Thus, when a communication package from the device includes device data, the proxy removes the device data and, e.g., replaces it with an account name. When a communication from SMA system 20 requires access to device data of a user, the proxy adds the necessary device data to the communication package.

In one illustrative embodiment that provides enhanced privacy, a user would 82 may be automatically assigned a new pseudonym by pseudonym manager when a change of zones is detected. For instance, it can be seen that user's pseudonym changed from abc to xyz after entering zone 80. This may be done by the proxy described above in order enhance security. Changing pseudonyms helps ensure that a third party cannot infer the user's real identity by tracking the user's movements.

Profile vectors (or simply “profiles”) may be stored for each user as well in the metadata 85, 87. The profile vector may be used for both private and standard mode users. Standard mode user profiles may include static and demographic type data of the user that is generally independent of SMA use, e.g., personal information including, age range, occupation, interests, etc. Both modes may include behavioral or dynamic type data that is dependent on interactions with the SMA system 20, e.g., ads the user clicked on, content from a post made or read by the user, length of time in the zone, number of times in the zone, etc.

Profile vectors may also capture information from a query system that interacts with individual users. The query system may for example be implemented using natural language (NL) interactions, multiple choice questions, or any other query format. For instance, a user may be asked (e.g., via text, instant messaging, voice, etc.) questions such as “are you visiting?”, “what do you want to do while in town?”, “are you a Giants fan?” etc. Responses may be utilized to fill out user profile vectors. For instance, if the user indicates he or she is visiting a zone for the first time, that data can be loaded into the profile. Similarly, if the user indicates that he or she is a fan of the home team at a sports event, that information can likewise be stored. Any type of information may be gathered and stored. For users in a privacy mode, the queries can be generic in nature so as to not potentially reveal identities or private information.

The profiles may be utilized to enhance the user experience in any manner, e.g., to better target content, to cluster similar users together, etc. Profile data elements may be maintained permanently, semi-permanently, temporarily, or some combination thereof. For example, profile data may be maintained only during an active session, only while in a zone, or permanently. Storage of profile data may depend on privacy settings of the user. To enhance security, profile data may be encrypted, and/or stored by the proxy.

NL Interactions may also provide customized content for the user and may, e.g., comprise voice or text based exchanges. For instance, the SMA system 20 may send the user a series of queries using stored or dynamically generated natural language messages, e.g.,

system: “any interest in seeing a show while in town?”

user: “maybe”

system: “broadway show? music concert? other?

user: “concert”

system: “cool—if you want to see a list of who's playing, click <here>” Accordingly, user responses may be analyzed using NL technologies to provide specific zone-based content for the user, e.g., ticket sales, community events, food, etc. In an alternative embodiment, the query system may simply present the user with multiple choice or yes/no queries, thus alleviating the need to interpret user responses.

As shown in FIG. 6, each zone may also include a set of zone metadata 88 that sets up aspects of the zone. For instance, zone metadata 88 may dictate a default type of sharing when zones overlap; a privacy setting for the zone; and what types of interaction external, third party users can engage in. The privacy setting may dictate, on one end of the spectrum, that all communications are free, open, and unsecured, or (or the other end of the spectrum) that communications must be secured with encryption, or anywhere in between. Further the privacy setting of the zone and the privacy setting of the user may be evaluated together by a zone privacy protocol 23 (FIG. 1) to dictate the type of privacy/security level afforded to the user while in the zone.

Zone metadata 88 may also include one or more keywords that are linked or associated with the zone. The keywords, which may be in the form of a hashtag, e.g. #FenwayPark, #RedSox, can be used as a search or explore term to drive third party content into the zone. For instance, SMA system 20 can be employed with hooks to pull content from other social media systems based on #hashtag searches. Accordingly, relevant content can be readily identified from external sources and made available for presentation in the zone.

In addition to managing user content and third party content, ISI 28 manages the distribution of advertising. As such, ISI 28 enables providers to readily target advertising content 33 to particular zones. Zone based advertising content is particularly effective since it is targeted to a very defined zone based audience. Accordingly, local businesses such as restaurants, bars, retail, etc., can leverage the zonal infrastructure created herein.

Data storage, including all content flowing into and out of SMA system 20, is handled by data management system 30 and data store 36. News, posts, photos, tweets, ad content, etc., can be stored in data store 36 for dissemination among connected users. Data store 36 may be implemented in any fashion and on any scale, e.g., using one or more of the following: a local memory or cache of the user's smart device running the SMA, a data warehouse, cloud storage, RAM, magnetic or fiber medium, system cache, etc. In different cases, content from a source may be (1) directly streamed to the user, (2) temporarily cached and/or (3) permanently stored.

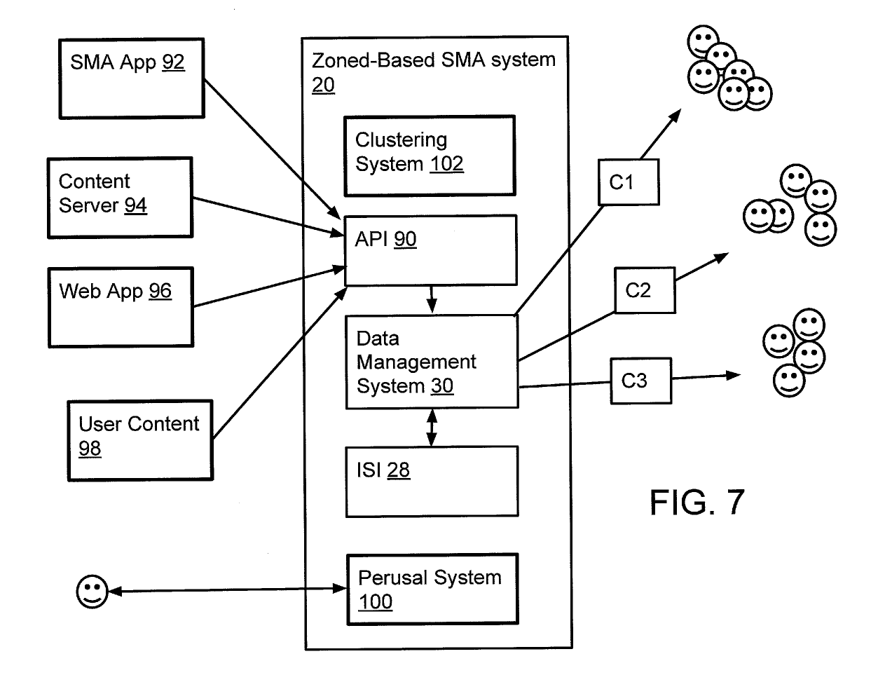

FIG. 7 shows zoned-based SMA system 20 further having an API 90 (Application Programming Interface) configured to receive content from multiple content sources (either pushed or pulled). In this manner, zoned-based SMA system 20 can be implemented to separately drive content from any number of content sources at the zone level, user cluster level, or user level. For example, zoned-based SMA system 20 may pull content from one or more of: a third party SMA application 92, a content server 94, a web app 96, user posted content 98, etc. An illustrative third party SMA application 92 may for example include Twitter, Facebook, Instagram, YouTube, etc., in which location relevant information is collected for redistribution (e.g., based on hashtags such as #NapaValley). An illustrative content server 94 may for example include an RSS news service, Hulu, blogs, a newspaper, multimedia, ESPN, government information, etc.; an illustrative web application 96 may include, e.g., a gaming program, a social media crawler that collects SMA content from different sources, a weather program, ticket sales websites, vacation rental websites, real estate websites, etc. Content may be collected in any manner, e.g., using bots or crawlers that pull data from any source. Third party content may be attributed to its source, e.g., with a frame or other identifying indicia.

As shown, content is evaluated/collected by data management system 30 and, with the assistance of ISI 28, content is selectively forwarded to different zones (i.e., the users residing in given zones), user clusters, or users. Any type or combination of content may be forwarded. Accordingly, a user entering a zone might for example receive posts from other users in the zone, ticket information for events occurring in the zone, local news regarding the zone, posts collected from other SMA applications relevant to the zone, ads for businesses in the zone, governmental broadcasts, weather reports, media broadcasts, real estate information, apartment rentals, streamed video and/or audio or any other type of content, collectively referred to as “zone-based content.”

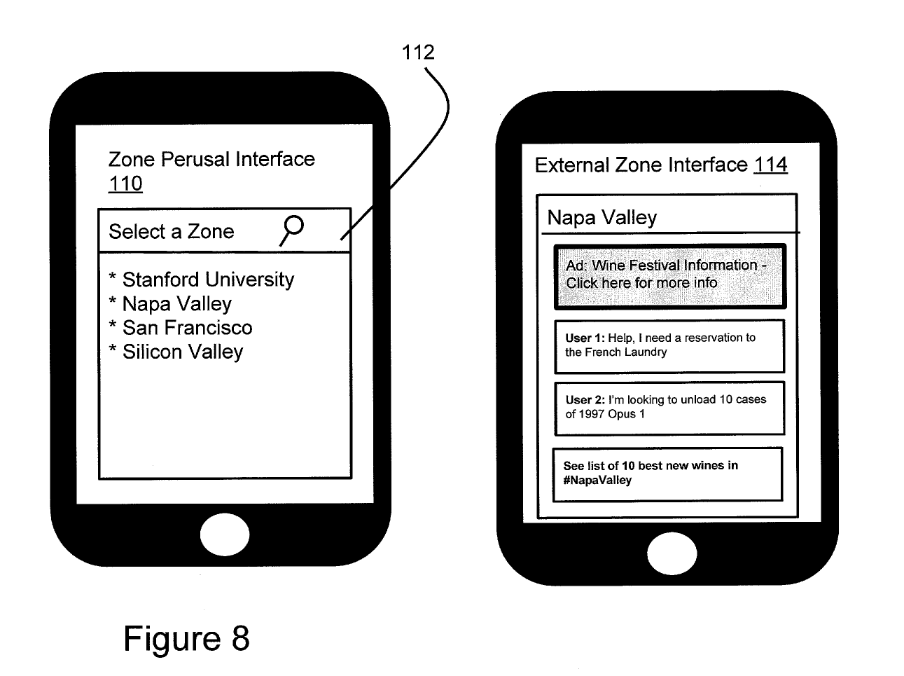

Zone-based SMA system 20 further includes a perusal system 100 for allowing an “external” user to observe content and optionally interact within a zone when the user is not actually located in the zone. For example, a user who is planning a trip to resort area may be interested in the content being exchanged within that zone ahead of time. Such a user could navigate to the Zone Perusal Interface 110 shown in FIG. 8. From this interface 110, the user can enter, search, select, or otherwise identify a zone of interest within a selection interface window 112. In the example shown, Napa Valley is selected to produce an external zone interface 114 that will display content in the predefined Napa Valley zone. Note that perusal system 100 may require that external users be subject to different rules (e.g., as dictated by a privacy protocol 23), such as whether they can post content, can be blocked from seeing content, must be a registered user, etc.

Zone-based SMA system 20 may also include a clustering system 102 for clustering users within a zone, or for clustering users completely independent of geospatial zones. For example, clustering system 102 could identify a cluster of “similar” users and optionally allow users to “leave” their current zone and join a more specialized cluster. Connections and content could therefore be refined to cluster-based user connections and/or content sources. Thus, content within a zone can be further filtered or tailored to a specific user profile or cluster definition.

The size and definition of each cluster can vary and be dynamic in nature, for instance based on: profile data collected for a set of users, the number of users in a zone, the amount of content available in the zone, etc. Thus for example, if there were too many users in a zone (e.g., 50,000 active users at a stadium watching a football game) that made delivering, posting and viewing relevant content impractical, clustering could be employed to intelligently manage the flow of content to users in the zone, and/or reduce the number of connections a given user in the zone would have.

Thus for example, a user's connections could be limited to those other users who have a similar profile vector. Similarly, third party content could also be filtered or clustered based on the user profile vector in which clustered users receive similar content.

A user's profile vector may comprise any set of demographic or profile elements associated with the user, e.g., age, income range, sex, interests, previous zones visited, number of times visiting this zone, purchase histories, behaviors, etc. As noted, the size of a created cluster could be based on any input, e.g., the number of users in a zone, an ideal cluster size, volume of content being directed into the zone, etc., and be dynamic in nature, growing and shrinking to achieve a desired user experience. Further, a user could be provided with an interface to (1) select clusters to join, and/or (2) adjust their profile parameters to change clusters.

Clustering may for example be implemented using k-means clustering to partition n observations (i.e., users) into k clusters in which each user belongs to the cluster with the nearest mean, serving as a prototype of the cluster. Given a set of observations (x₁, x₂, . . . , xₙ), where each observation is a d-dimensional real vector, k-means clustering aims to partition the n observations into k sets (k≦n) S={S₁, S₂, . . . , Sₖ} so as to minimize the within-cluster sum of squares (WCSS):

$${arg min}_{S} {\sum }_{i = 1}^{k} {\sum }_{{x}_{j} ∈ {S}_{i}}^{ } {‖ {x}_{j} - {μ}_{i} ‖}^{2}$$

where μᵢ is the mean of points in Sᵢ.

A possible algorithm may use an iterative refinement technique as follows. Given an initial set of k means m₁⁽¹⁾, . . . , mₖ⁽¹⁾ (see below), the algorithm proceeds by alternating between two steps:

Assignment Step:

Assign each observation to the cluster whose mean yields the least within-cluster sum of squares (WCSS). Since the sum of squares is the squared Euclidean distance, this is intuitively the “nearest” mean.

Sᵢ^{(t)}={xₚ:∥xₚ−mᵢ^{(t)}∥²≦∥xₚ−mⱼ^{(t)}∥²∀1≦j≦k},

where each xₚ is assigned to exactly one S^{(t)}, even if it could be is assigned to two or more of them.

Update Step:

Calculate the new means to be the centroids of the observations in the new clusters.

$${m}_{i}^{( t + 1 )} = \frac{1}{\vert {S}_{i}^{( t )} \vert} {\sum }_{{x}_{j} ∈ {S}_{i}^{( t )}}^{ } {x}_{j}$$

Since the arithmetic mean is a least-squares estimator, this also minimizes the within-cluster sum of squares (WCSS) objective. The algorithm has converged when the assignments no longer change. Since both steps optimize the WCSS objective, and there only exists a finite number of such partitionings, the algorithm must converge to a (local) optimum. It is understood that other type of clustering algorithms could likewise be utilized, e.g., hierarchical clustering.

In addition, it is understood that clustering may be utilized to cluster any type of content around a center or mean “user”, dependently or independently of zones. For example, user reviews of travel or restaurant locations may be clustered. Thus, a user could be assigned to one of a plurality of possible clusters and receive reviews prioritized to the cluster. For example, a middle age, professional, married person living in an urban city, having a particular travel history would be associated with cluster of similar users. Such users would likely have more discriminating tastes in restaurants that a cluster of users made up of college students, living in dorm rooms, on fixed budgets. Accordingly, restaurant and travel reviews could be prioritized based on cluster membership, where cluster members would receive reviews by other reviewers in the same cluster with a higher priority.

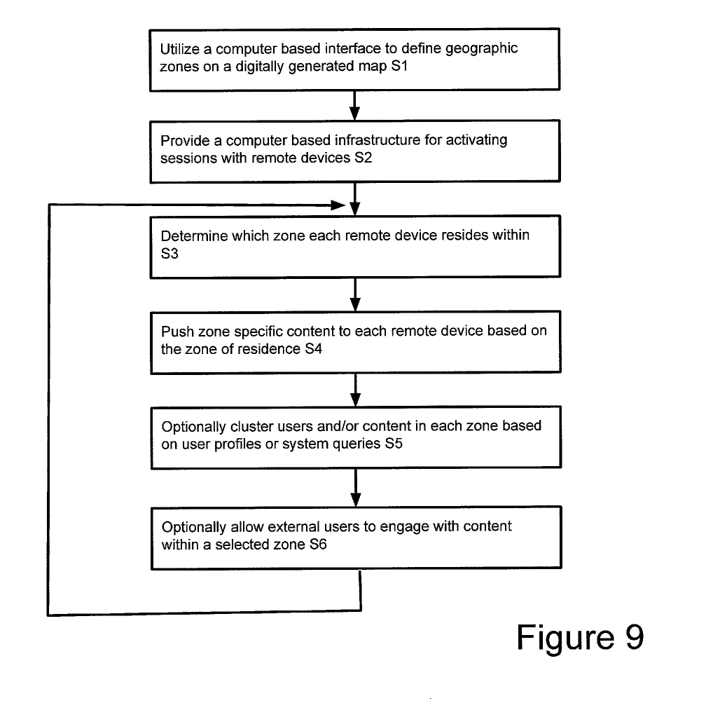

FIG. 9 depicts an illustrative flow diagram showing a method of implementing a zone based SMA system. At S1, a computer based interface is utilized to define geographic zones on a digitally generated map and at S2, a computer based infrastructure is utilized for activating sessions with remote devices over a computerized network. At S3, the computer based infrastructure determines which zone each active device resides within. At S4, zone specific content is pushed to each active device based on its zone of residence. At S5, the zone specific content can be optionally clustered for users based on user profiles or queries/responses directed/collected from the user, and at S6, the zone specific content can be made available for engagement to external users. The process then loops back to S3.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “system.” Furthermore, aspects of the present invention may take the form of a computer program product embodied in one or more computer readable medium(s) having computer readable program code embodied thereon.

Any combination of one or more computer readable medium(s) may be utilized. The computer readable medium comprises a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Alternatively, the program product could be embodied on computer readable signal medium which may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer system 10 of FIG. 1 may comprise any type of computing device and is shown including a one or more processors 14, memory 12, an input/output (I/O) 16 (e.g., one or more I/O interfaces and/or devices), and a communications pathway 17. In general, processor(s) 14 execute program code, such as zone-based SMA system 18, which is at least partially fixed in memory 12. While executing program code, processor(s) 14 can process data, which can result in reading and/or writing transformed data from/to memory 12 and/or I/O 16 for further processing. Pathway 17 provides a communications link between each of the components in computer system 10. I/O 16 can comprise one or more human I/O devices, which enable a user to interact with computer system 10. To this extent, zone-based SMA system 18 can manage a set of interfaces (e.g., graphical user interface(s), application program interface, and/or the like) that enable human and/or system users to interact with the zone-based SMA system 18. Further, zone-based SMA system 18 can manage (e.g., store, retrieve, create, manipulate, organize, present, etc.) data, such as data in profile database 26, using any solution.

In any event, computer system 10 can comprise one or more general purpose computing articles of manufacture (e.g., computing devices) capable of executing program code. As used herein, it is understood that “program code” means any collection of instructions, in any language, code or notation, that cause a computing device having an information processing capability to perform a particular action either directly or after any combination of the following: (a) conversion to another language, code or notation; (b) reproduction in a different material form; and/or (c) decompression. To this extent, configuration management system 18 can be embodied as any combination of system software and/or application software.

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Note that the claims that follow are not intended in any way to limit the potential scope of this invention, and different claims may be later presented which are entitled to the filing date of this disclosure. Such new claims may broaden what is presented and/or encompass different subject matter altogether.

1. A zone-based social media application (SMA) system implemented on a computing system having a processor and memory, comprising:
a zone management system that employs a computerized process for managing a plurality of predefined geospatial zones, wherein the plurality of predefined geospatial zones include overlapping zones;
a client management system that employs a computerized process for managing sessions with remote SMA clients;
a locator system that employs a computerized process to associate each remote SMA client engaged in an active session with a predefined geospatial zone, wherein the locator system includes a process for selecting the predefined geospatial zone from a set of overlapping zones in response to an SMA client being located in an area predefined with overlapping zones; and
a content information sharing infrastructure that employs a computerized process to deliver distinguishable sets of content to remote SMA clients based on an associated geospatial zone.

2. The zone-based SMA of claim 1, wherein the predefined geospatial zone comprises an area on a map having a defined boundary.

3. The zone-based SMA of claim 1, wherein the client management system includes a system for implementing anonymous user sessions with remote SMA clients, wherein the anonymous user sessions are implemented without a permanent user account.

4. The zone-based SMA of claim 3, wherein anonymous user sessions are implemented over a secure communication channel.

5. The zone-based SMA of claim 3, wherein at least of a portion of the content delivered by content sharing infrastructure is encrypted.

6. The zone-based SMA of claim 1, wherein the locator system utilizes GPS data gathered by a remote SMA client to determine an associated predefined geospatial zone.

7. The zone-based SMA of claim 1, wherein the locator system utilizes a user input to determine an associated predefined geospatial zone.

8. The zone-based SMA of claim 1, wherein each distinguishable set of content includes zone-specific content.

9. The zone-based SMA of claim 8, wherein the zone-specific content includes posts by users residing in a common geospatial zone.

10. The zone-based SMA of claim 8, wherein the zone-specific content includes content from external applications.

11. The zone-based SMA of claim 1, wherein remote SMA clients within zones are clustered based on profile vectors, and wherein each cluster receives cluster based content.

12. The zone-based SMA of claim 1, further comprising a query system for querying individual users for information to assist in targeting content to the individual users.

13. The zone-based SMA of claim 1, wherein the process for selecting the predefined geospatial zone from a set of overlapping zones includes receiving a selection from an end user.

14. The zone-based SMA of claim 1, wherein the process for selecting the predefined geospatial zone from a set of overlapping zones is based on a profile vector of the user.

15. A computer program product stored on a computer readable medium, which when executed by a computer system, implements a zone-based social media application (SMA) system, comprising:
program code for managing a plurality of predefined geospatial zones;
program code for managing sessions with remote SMA clients;
program code to associate each remote SMA client engaged in an active session with at least one predefined geospatial zone;
program code to deliver distinguishable sets of content to remote SMA clients based on an associated geospatial zone; and
program code to cluster SMA clients into separate clusters within at least one predefined geospatial zone based on profile vectors, wherein each cluster receives cluster based content.

16. The computer program product of claim 15, further comprising program code for querying end users for information to assist in clustering SMA clients.

17. The computer program product of claim 16, wherein the program code for querying end users utilizes natural language processing.

18. A computerized method for implementing a zone-based social media application (SMA) system, comprising:
managing a plurality of predefined geospatial zones;
managing sessions with remote SMA clients;
associating each remote SMA client engaged in an active session with at least one predefined geospatial zone;
generating queries to end users and receiving responses to queries; and
delivering distinguishable sets of content to remote SMA clients based on an associated geospatial zone and based on received responses.

19. The computerized method of claim 18, wherein the predefined geospatial zones include overlapping zones, and wherein an associated geospatial zone is determined based on a received response when a remote SMA client is located in an area defined with overlapping zones.

20. The computerized method of claim 18, wherein generating queries and receiving responses is done using natural language processing.
